(19) United States
(12) Patent Application Publication
(10) Pub. No.: US 2015/0137945 A1
(43) Pub. Date: May 21, 2015

(54) TWO-WAY FINDING SYSTEM

(71) Applicant: Fong-Hao Chiang, (US)

(72) Inventors: Fong-Hao CHIANG, Taichung City (TW); Kuan-Yu CHEN, Taichung City (TW)

(73) Assignee: Fong-Hao Chiang, Taichung City (TW)

(21) Appl. No.: 14/259,549

(22) Filed: Apr. 23, 2014

(30) Foreign Application Priority Data
Nov. 21, 2013 (TW) 102142465

(51) Int. Cl. G08B 5/22; G08B 25/10; G08B 7/06

(52) U.S. Cl. CPC G08B 5/224; G08B 7/06; G08B 25/10
USPC 340/8.1

(57) ABSTRACT

A two-way finding system includes a first wireless transceiver device and a second wireless transceiver device. The first wireless transceiver device is generated a second wireless transceiver device calling signal that contains a first identification code, a first communication address and a second identification code. The second wireless transceiver device is received the second wireless transceiver device calling signal and to generate a reminder signal according to the second identification code of the second wireless transceiver device calling signal. The second wireless transceiver device is generated a first wireless transceiver device calling signal that contains a second identification code, a second communication address and a first identification code. The first wireless transceiver device is received the first wireless transceiver device calling signal and to generate a reminder signal according to the first identification code of the first wireless transceiver device calling signal.

### BACKGROUND OF THE INVENTION

1. Field of the Invention

The present invention relates to two-way remote control technology and more particularly, which a two-way finding system that provides multiple application modes.

2. Description of the Related Art

In everyday life, the problem of finding an item (such as key, TV remote controller, cell phone, watch, purse, glasses, etc.) happens frequently in our daily life. This problem gets you to spend a lot of time, making you feel upset. Further, if you have young children at home or when going out with young children, parents often worry about having their young children out of sight, causing safety concerns.

In view of the above described problem, Taiwan Utility M353583 created a two-way remote control system. According to this design, when a call (request) button of a first wireless transceiver device is pressed, the first wireless transceiver device transmits a call (request) signal to a second wireless transceiver device, and the second wireless transceiver device reads the call (request) signal and transmits a reply signal to the first wireless transceiver device when a reading button thereof is pressed, and thus, the first and second wireless transceivers achieve calling each other. In actual application, if the user carries the first wireless transceiver and the second wireless transceiver is attached to a watch, the first wireless transceiver and the second wireless transceiver cannot call each other due to that the watch cannot press the reading button, and thus the user cannot find the watch.

### SUMMARY OF THE INVENTION

The present invention has been accomplished under the circumstances in view. It is the main object of the present invention to provide a two-way finding system that enables quick identification of the location of a specified item and avoids the risk of losing the child.

To achieve this and other objects of the present invention, a two-way finding system in accordance with the present invention comprises a first wireless transceiver device and a second wireless transceiver device. The first wireless transceiver device comprises a first processor, a first battery, a first input module, a first output module, and a first wireless communication module. The first battery, the first input module, the first output module and the first wireless communication module are electrically connected to the first processor. The first processor has stored therein a first identification code and a first communication address. The second wireless transceiver device comprises a second processor, a second battery, a second input module, a second output module, a second wireless communication module. The second battery, the second input module, the second output module and the second wireless communication module are electrically connected to the second processor. The second processor has stored therein a second identification code and a second communication address. The first input module triggers the first processor to generate a second wireless transceiver device calling signal. The second wireless transceiver device calling signal generated by the first wireless transceiver device is transmitted to the second wireless transceiver device through the first wireless communication module. The second wireless transceiver device calling signal generated by the first wireless transceiver device contains a first identification code, a first communication address and a second identification code, After the second wireless communication module received the second wireless transceiver device calling signal from the first wireless transceiver device, the second processor generates a reminder signal according to the second identification code of the second wireless transceiver device calling signal of the first wireless transceiver device, enabling the reminder signal to be outputted through the second output module. The second input module triggers the second processor to generate a first wireless transceiver device calling signal. The first wireless transceiver device calling signal generated by the second wireless transceiver device is transmitted to the first wireless transceiver device through the second wireless communication module. The first wireless transceiver device calling signal generated by the second wireless transceiver device contains the second identification code, the second communication address and the first identification code. After the first wireless communication module received the first wireless transceiver device calling signal from the second wireless transceiver device, the first processor generates a reminder signal according to the first wireless transceiver device calling signal of the second wireless transceiver device, enabling the reminder signal to be outputted through the first output module.

Preferably, the first input module triggers the first processor to generate a second wireless transceiver device monitoring signal. The second wireless transceiver device monitoring signal is transmitted to the second wireless transceiver device through the first wireless communication module. After the second wireless communication module received the second wireless transceiver device monitoring signal from the first wireless transceiver device, the second processor generates a plurality of return signals in a plurality of return cycles according to the second wireless transceiver device monitoring signal of the first wireless transceiver device, enabling the return signals to the transmitted to the first wireless transceiver device through the second wireless communication module. The first processor controls the first wireless communication module to receive each return signal when each received time interval is up. The first processor generates an alarm signal subject to an alarm condition, enabling the alarm signal to be outputted through the first output module. The alarm condition is that the first wireless communication module receives no return signal when said received time interval is up.

### BRIEF DESCRIPTION OF THE DRAWINGS

FIG. 1 is a system block diagram of a two-way finding system in accordance with the present invention.

FIGS. 2A-2D illustrate the operating status of the two-way finding system under the individual calling mode.

FIGS. 3A-3C illustrate the operating status of the two-way finding system under the all-call calling mode.

FIG. 4 illustrates the operating status of the two-way finding system under the parent-child mode.

FIG. 5 illustrates the cycling of the operating time and sleep time of return cycles of the two-way finding system under the parent-child mode.

### DETAILED DESCRIPTION OF THE INVENTION

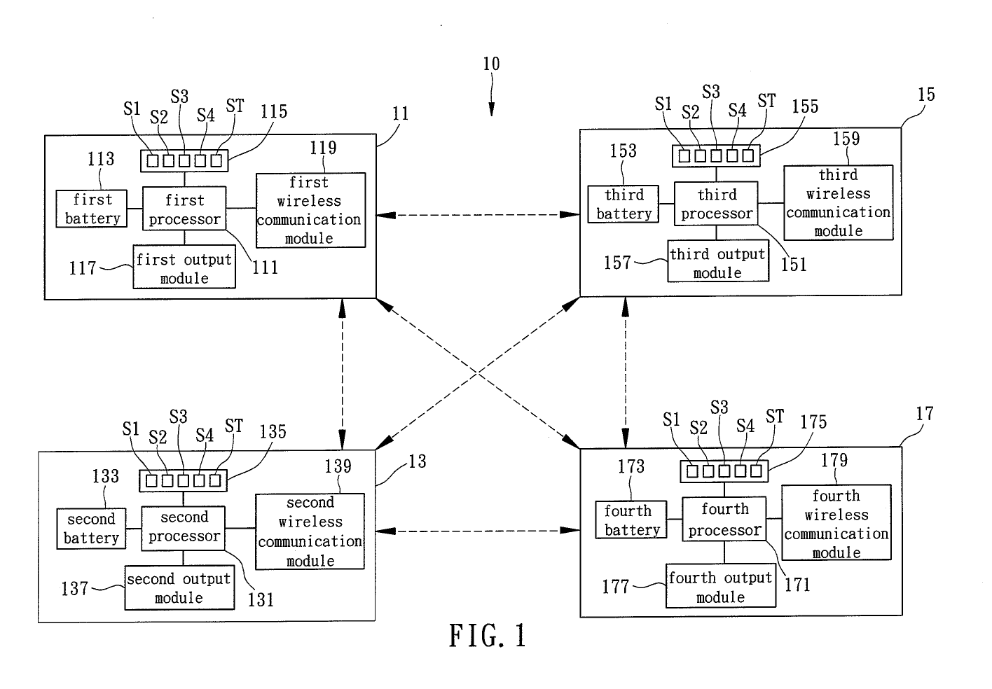

Referring to FIG. 1, a two-way finding system in accordance with the present invention is shown. As illustrated, the two-way finding system 10 comprises a first wireless transceiver device 11, a second wireless transceiver device 13, a third wireless transceiver device 15, and a fourth wireless transceiver device 17. These modules 11-17 can communication with one another through a wireless network. In actual application, these modules 11-17 can be joined to articles or worn on children for quickly finding the location of the articles to avoid lost children. Although the above description stated an application example of the present invention, the present invention can still be used for other applications, and therefore, the present invention is not limited to the above application.

The first wireless transceiver device 11 comprises a first processor 111, a first battery 113, a first input module 115, a first output module 117, and a first wireless communication module 119.

The second wireless transceiver device 13 comprises a second processor 131, a second battery 133, a second input module 135, a second output module 137, and a second wireless communication module 139.

The third wireless transceiver device 15 comprises a third processor 151, a third battery 153, a third input module 155, a third output module 157, and a third wireless communication module 159.

The fourth wireless transceiver device 17 comprises a fourth processor 171, a fourth battery 173, a fourth input module 175, a fourth output module 177, and a fourth wireless communication module 179.

The processors 111, 131, 151 and 171 are respectively electrically connected to the respective batteries 113, 133, 153 and 173 for receiving electric energy from the respective batteries 113, 133, 153 and 173. The first processor 111 has stored therein a first identification code, an all-call calling code and a first communication address. The second processor 131 has stored therein a second identification code, an all-call calling code and a second communication address. The third processor 151 has stored therein a third identification code, an all-call calling code and a third communication address. The fourth processor 171 has stored therein a fourth identification code, an all-call calling code and a fourth communication address. The identification codes in the processors 111, 131, 151 and 171 of the wireless transceiver devices 11, 13, 15 and 17 are different. However, these wireless transceiver devices 11, 13, 15 and 17 have the same all-call calling code stored in the respective processors 111, 131, 151 and 171.

The input modules 115, 135, 155 and 175 of the wireless transceiver devices 11, 13, 15 and 17 are respectively electrically connected to the respective processors 111, 131, 151 and 171 for triggering respective processors 111, 131, 151 and 171. These input modules 115, 135, 155 and 175 each comprise a first switch S1, a second switch S2, a third switch S3, a fourth switch S4, and an all-call switch ST. In this embodiment, these switches S1, S2, S3, S4 and ST are normally open switches. The characteristic of a normally open switch is that the connection is not made until you push a button; when the button is released, the connection is broken.

The output modules 117, 137, 157 and 177 of the wireless transceiver devices 11, 13, 15 and 17 are respectively electrically connected to the respective processors 111, 131, 151 and 171.

The wireless communication modules 119, 139, 159 and 179 of the wireless transceiver devices 11, 13, 15 and 17 are respectively electrically connected to the respective processors 111, 131, 151 and 171 for receiving and transmitting wireless signals. Further, these wireless communication modules 119, 139, 159 and 179 are configured to meet the wireless protocols of IEEE802.11 standards and Bluetooth profiles.

According to the above description, these wireless transceiver devices 11, 13, and 17 have the same composition, however, every one of these wireless transceiver devices 11, 13, 15 and 17 has its own ID code.

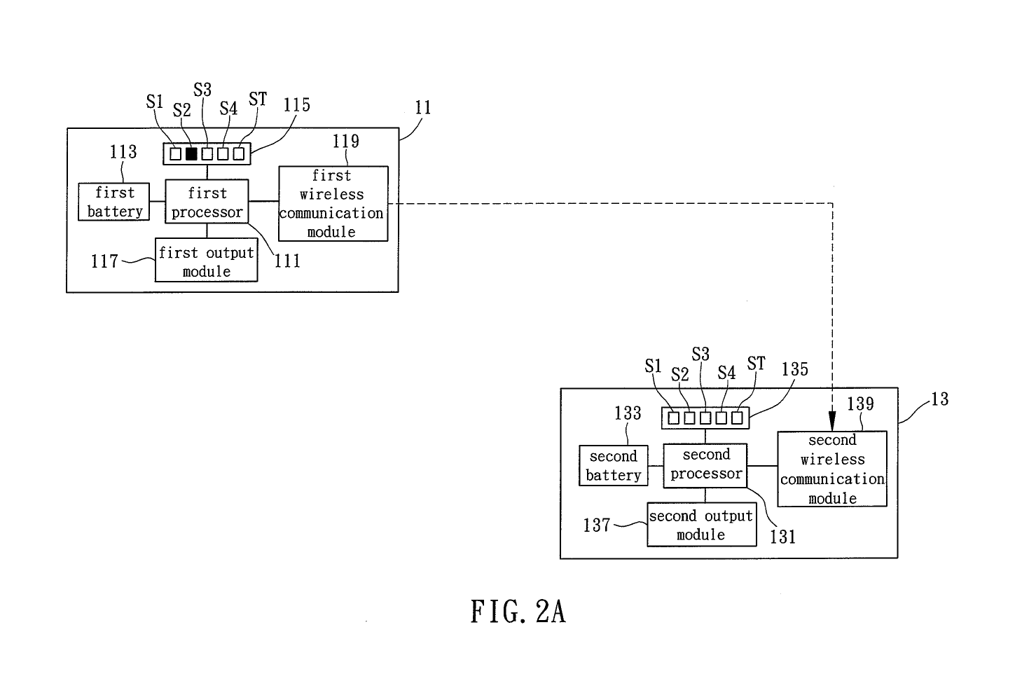

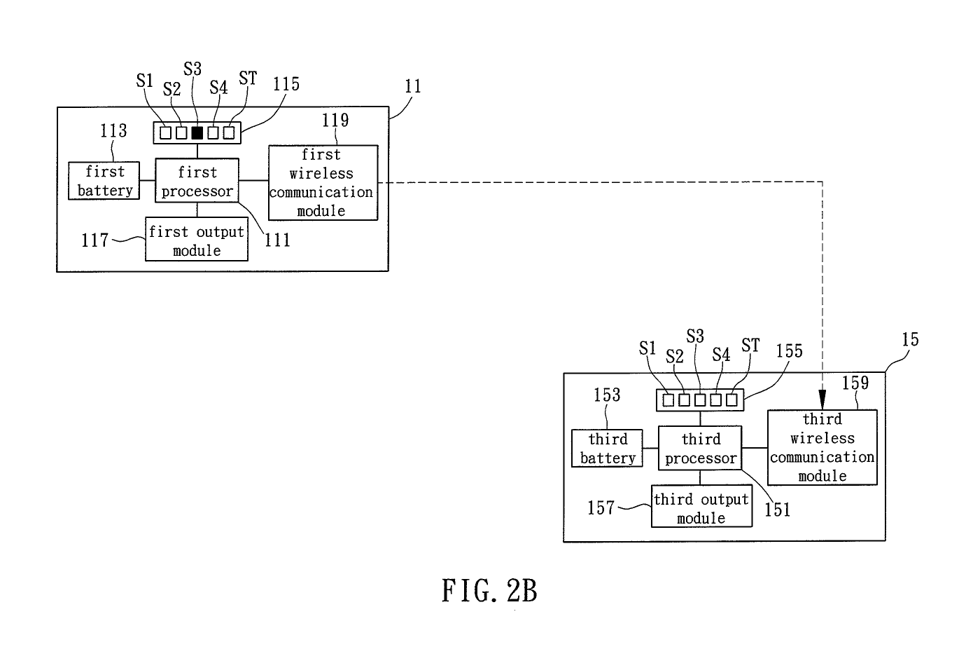

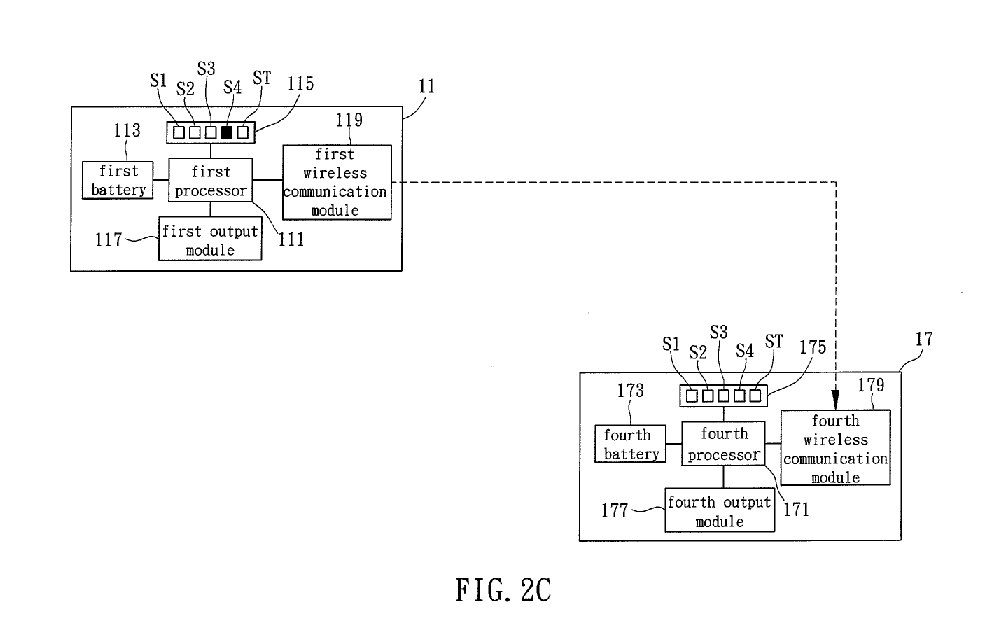

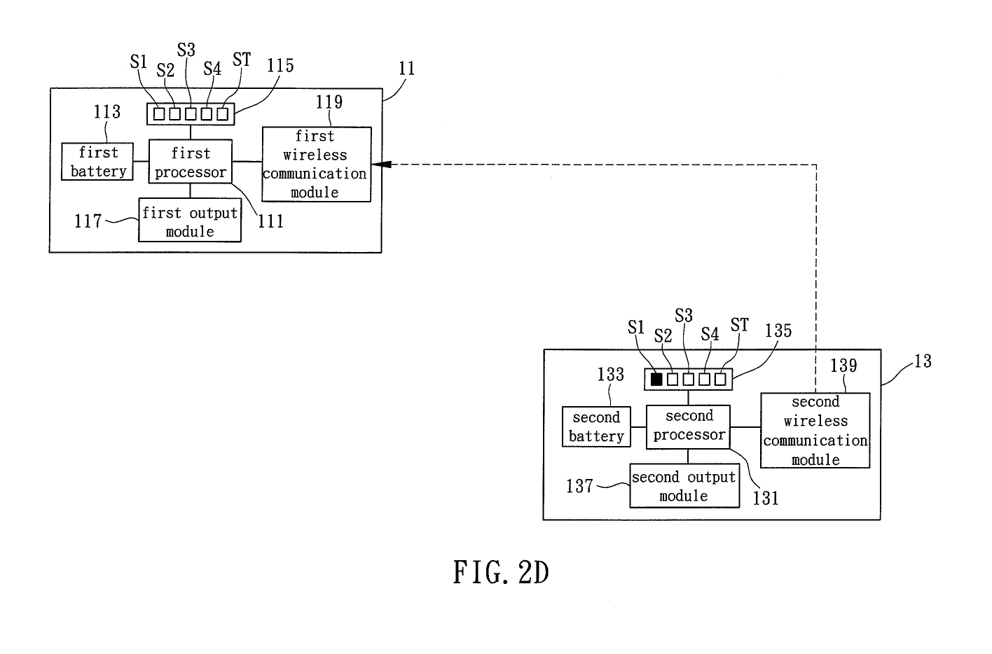

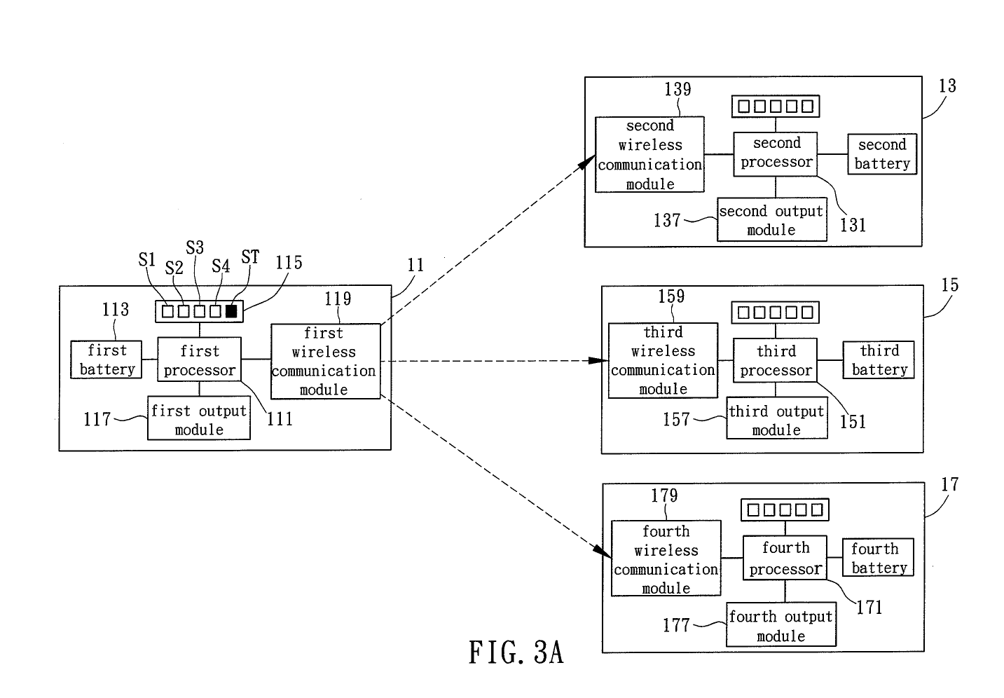

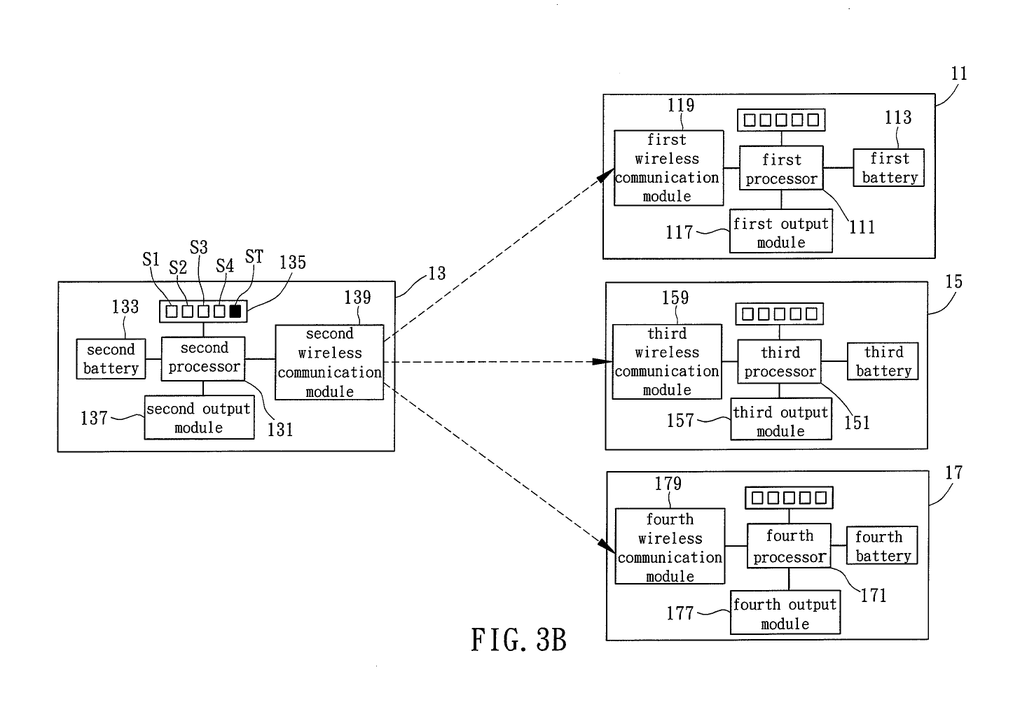

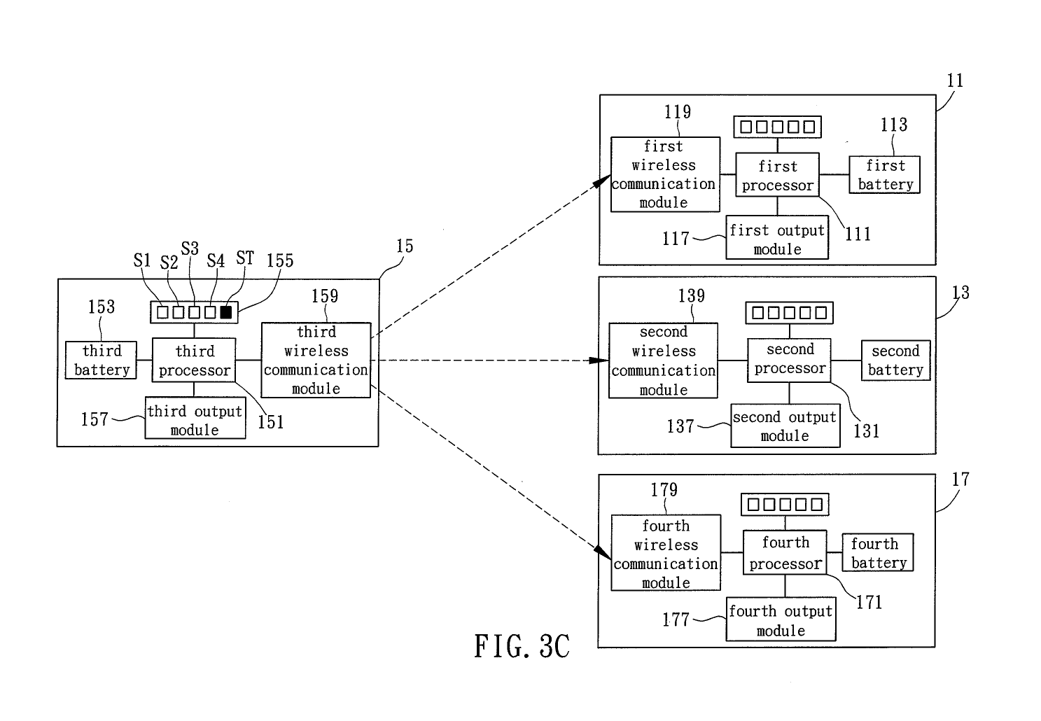

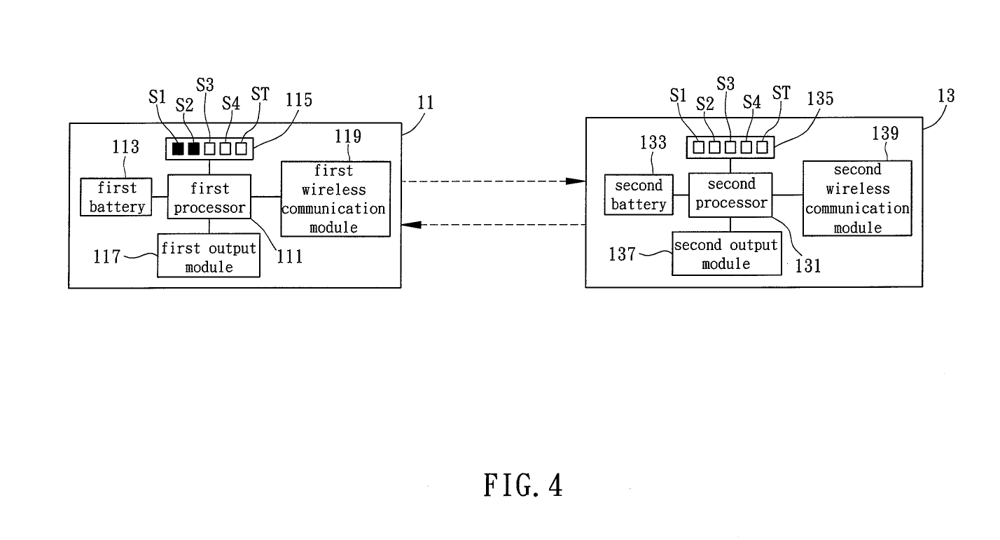

In actual application, the two-way finding system can be operated in three modes. The first operating mode is an individual calling mode (see FIGS. 2A-2D). The second operating mode is an all-call calling mode (see FIGS. 3A-3C). The third operating mode is a parent-child mode (see FIG. 4). These three operating modes are outlined hereinafter one by one.

In the individual calling mode, as shown in FIG. 2A, if the second switch S2 of the first input module 115 is electrically conducted (see the black-colored block in the drawing), it means that the first wireless transceiver device 11 is calling the second wireless transceiver device 13. At this time, the first processor 111 generates a second wireless transceiver device calling signal that is then transmitted to the second wireless transceiver device 13 by the first wireless communication module 119. The second wireless transceiver device calling signal of the first wireless transceiver device 11 contains the first identification code, the first communication address and the second identification code. Immediately after the second wireless communication module 139 received the second wireless transceiver device calling signal of the first wireless transceiver device 11, the second processor 131 generates a reminder signal according to the second identification code of the second wireless transceiver device calling signal of the first wireless transceiver device 11, enabling the reminder signal to be outputted through the second output module 137. At this time, the third wireless transceiver device 15 and the fourth wireless transceiver device 17 do no work, and are maintained in a standby mode.

Referring to FIG. 2B, if the third switch S3 of the first input module 115 is electrically conducted (see the black-colored block in the drawing), it means that the first wireless transceiver device 11 is calling the third wireless transceiver device 15. At this time, the first processor 111 generates a third wireless transceiver device calling signal that is then transmitted to the third wireless transceiver device 15 by the first wireless communication module 119. The third wireless transceiver device calling signal of the first wireless transceiver device 11 contains the first identification code, the first communication address and the third identification code. Immediately after the third wireless communication module 159 received the third wireless transceiver device calling signal of the first wireless transceiver device 11, the third processor 151 generates a reminder signal according to the third identification code of the second wireless transceiver device calling signal of the first wireless transceiver device 11, enabling the reminder signal to be outputted through the third output module 157. At this time, the second wireless transceiver device 13 and the fourth wireless transceiver device 17 do no work, and are maintained in a standby mode.

Referring to FIG. 2C, if the fourth switch S4 of the first input module 115 is electrically conducted (see the black-colored block in the drawing), it means that the first wireless transceiver device 11 is calling the fourth wireless transceiver device 17. At this time, the first processor 111 generates a fourth wireless transceiver device calling signal that is then transmitted to the fourth wireless transceiver device 17 by the first wireless communication module 119. The fourth wireless transceiver device calling signal of the first wireless transceiver device 11 contains the first identification code, the first communication address and the fourth identification code. Immediately after the fourth wireless communication module 179 received the third wireless transceiver device calling signal of the first wireless transceiver device 11, the fourth processor 171 generates a reminder signal according to the third identification code of the second wireless transceiver device calling signal of the first wireless transceiver device 11, enabling the reminder signal to be outputted through the fourth output module 177. At this time, the second wireless transceiver device 13 and the third wireless transceiver device 15 do no work, and are maintained in a standby mode.

Similarly, as shown in FIG. 2D, if the first switch S1 of the second input module 135 is electrically conducted (see the black-colored block in the drawing), it means that the second wireless transceiver device 13 is calling the first wireless transceiver device 11. At this time, the second processor 131 generates a fourth wireless transceiver device calling signal that is then transmitted to the first wireless transceiver device 11 by the second wireless communication module 139. The first wireless transceiver device calling signal of the second wireless transceiver device 13 contains the second identification code, the second communication address and the first identification code. Immediately after the first wireless communication module 119 received the first wireless transceiver device calling signal of the second wireless transceiver device 13, the first processor 111 generates a reminder signal according to the first identification code of the first wireless transceiver device calling signal of the second wireless transceiver device 13, enabling the reminder signal to be outputted through the first output module 117. At this time, the third wireless transceiver device 15 and the fourth wireless transceiver device 17 do no work, and are maintained in a standby mode.

It is to be noted that the first switch S1 of the first wireless transceiver device 11 represents the first wireless transceiver device 11 itself; the second switch S2 of the second wireless transceiver device 13 represents the second wireless transceiver device 13 itself; the third switch S3 of the third wireless transceiver device 15 represents third wireless transceiver device 15 itself; the fourth switch S4 of the fourth wireless transceiver device 17 represents fourth wireless transceiver device 17 itself. If the switch of one wireless transceiver device that represents the respective wireless transceiver device is electrically conducted, the respective wireless transceiver device does not perform other functions.

As stated above, the first through fourth switches of the input module of every wireless transceiver device respectively represent first through fourth wireless transceiver devices, i.e., every wireless transceiver device can call one particular other wireless transceiver device by switching on the respective switch, and the wireless transceiver device been called will generate a sound to indicate its current location after received the calling signal. Because every wireless transceiver device has switches corresponding to the other wireless transceiver devices, every wireless transceiver device can call any other wireless transceiver device. As this calling operation is same as the procedure described above, no further detailed description in this regard will be necessary.

In the all-call calling mode, as shown in FIG. 3A, if the all-call switch ST of the first input module 115 is electrically conducted (see the black-colored block in the drawing), it means that the first wireless transceiver device 11 is calling the second, third and fourth wireless transceiver devices 13, 15 and 17. At this time, the first processor 111 generates an all-call calling signal that is then transmitted to the second wireless transceiver device 13, the third wireless transceiver device 15 and the fourth wireless transceiver device 17 by the first wireless communication module 119. The all-call calling signal of the first wireless transceiver device 11 contains the first identification code, the first communication address and the all-call calling code. Immediately after the second, third and fourth wireless communication modules 139, 159 and 179 received the all-call calling signal of the first wireless transceiver device 11, the second, third and fourth processors 131, 151 and 171 of the second, third and fourth wireless transceiver devices 13, 15 and 17 respective generate a reminder signal according to the all-call calling code of the first wireless transceiver device 11, enabling the reminder signal to be respectively outputted through the second, third and fourth output module 137, 157 and 177.

Referring to FIG. 3B, if the all-call switch ST of the second input module 135 is electrically conducted (see the black-colored block in the drawing), the second processor 131 will generate an all-call calling signal that will then be transmitted to the first wireless transceiver device 11, the third wireless transceiver device 15 and the fourth wireless transceiver device 17 by the second wireless communication module 139. The all-call calling signal of the second wireless transceiver device 13 contains the second identification code, the second communication address and the all-call calling code. Immediately after the first, third and fourth wireless communication modules 119, 159 and 179 received the all-call calling signal of the second wireless transceiver device 13, the first, third and fourth processors 111, 151 and 171 of the first, third and fourth wireless transceiver devices 11, 15 and 17 respectively generate a reminder signal according to the all-call calling code of the second wireless transceiver device 13, enabling the reminder signal to be respectively outputted through the first, third and fourth output modules 117, 157 and 177.

Referring to FIG. 3C, if the all-call switch ST of the third input module 155 is electrically conducted (see the black-colored block in the drawing), the third processor 151 will generate an all-call calling signal that will then be transmitted to the first wireless transceiver device 11, the second wireless transceiver device 13 and the fourth wireless transceiver device 17 by the third wireless communication module 159. The all-call calling signal of the third wireless transceiver device 15 contains the third identification code, the third communication address and the all-call calling code. Immediately after the first, second and fourth wireless communication modules 119, 139 and 179 received the all-call calling signal of the third wireless transceiver device 15, the first, second and fourth processors 111, 131 and 171 of the first, second and fourth wireless transceiver devices 11, 13 and 17 respectively generate a reminder signal according to the all-call calling code of the third wireless transceiver device 15, enabling the reminder signal to be respectively outputted through the first, second and fourth output modules 117, 137 and 177.

Similarly, when the all-call switch St of the fourth input module 175 is electrically conducted, the fourth wireless transceiver device 17 transmits an all-call calling signal to the first wireless transceiver device 11, the second wireless transceiver device 13 and the third wireless transceiver device 15, and the first wireless transceiver device 11, the second wireless transceiver device 13 and the third wireless transceiver device 15 will generate a reminder signal according to the all-call calling code. Thus, when the all-call switch ST of one of the first, second, third and fourth wireless transceiver devices 11, 13, 15 and 17 of the two-way finding system is electrically conducted, the output modules of other wireless transceiver devices will output a reminder signal.

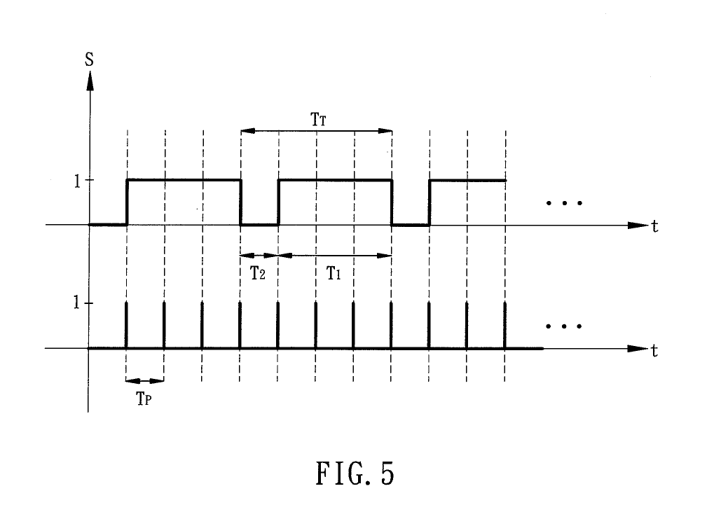

In the parent-child mode, as shown in FIGS. 4 and 5, one wireless transceiver device, for example, the second wireless transceiver device 13 is set as a child wireless transceiver device, and the other wireless transceiver devices (the first wireless transceiver device 11, the third wireless transceiver device 15 and the fourth wireless transceiver device 17) are selectively set as a parent wireless transceiver device. The setting method is to trigger the switch of the parent wireless transceiver device that represents the parent wireless transceiver device and the switch of the parent wireless transceiver device that represents the child wireless transceiver device for a predetermined length of time, for example, 5 seconds. For example, when making the aforesaid setting on the first wireless transceiver device 11 (parent wireless transceiver device), the first switch 51 (that represents the parent wireless transceiver device) and second switch S2 (that represents the child wireless transceiver device) of the first input module 115 (see the black-colored blocks in the drawing) are electrically conducted at the same time. When continuously conducted for a time period of 5 seconds, the first processor 111 generates a second wireless transceiver device monitoring signal that is then transmitted to the second wireless communication module 139 by the first wireless communication module 119. Upon receipt of the second wireless transceiver device monitoring signal by the second wireless communication module 139, the second processor 131 generates a return signal that is then transmitted by the second wireless communication module 139 to the first wireless transceiver device 11, and thus the setting is done.

Similarly, the third wireless transceiver device 15 and the fourth wireless transceiver device 17 can also be set as a parent wireless transceiver device. Thus, the first wireless transceiver device 11, the third wireless transceiver device 15 and the fourth wireless transceiver device 17 can be synchronously set as parent wireless transceiver devices.

Referring to FIG. 5, after setting of the parent-child mode, the second processor 131 will generate multiple return signals in multiple return cycles T_{T}, and the return signals will be transmitted by the second wireless communication module 139. Further, the first processor 111 controls the first wireless communication module 119 to receive a return signal from the second wireless transceiver device 13 when a received time interval T_{P} is up. When the received time interval T_{P} is up, the trigger status indicated in the drawing occurs. In particularly, the first processor 111 controls the first wireless communication module 119 not to receive any return signal in the received time interval T_{P}, i.e., the first wireless transceiver device 11 is under the sleep mode to save power consumption.

Further, every return cycle T_{T} contains an operating time T₁ and a sleep time T₂. The second processor 131 generates return signals in the operating time T₁, i.e., the second wireless transceiver device 13 is working. The second processor 131 stops generating return signals in the sleep time T₂, i.e., the second wireless transceiver device 13 is in sleep mode. It is to be noted that the received time interval T_{P} and the sleep time in this embodiment are set to be 1 second, and the operating time in this embodiment is set to be 3 seconds. Thus, if the parent wireless transceiver device and the child wireless transceiver device are in the effective communication range, the parent wireless transceiver device will receive a return signal from the child wireless transceiver each time the operating time is up.

If the first wireless communication module 119 keeps receiving a return signal from the second wireless transceiver device 13 when each received time interval T_{P} is up, the first wireless transceiver device 11 (parent wireless transceiver device) does not make any treatment and will wait for receiving another return signal when a next received time interval T_{P} is up. If the first wireless communication module 119 receives no any return signal from the second wireless transceiver device 13 when one received time interval T_{P} is up, the first processor 111 immediately generates an alarm signal subject to an alarm condition, and outputs this alarm signal through the first output module 117. The alarm condition is that the first wireless communication module 119 receives no any return signal from the second wireless transceiver device 13 when one received time interval T_{P} is up. Thus, when the child wireless transceiver device moves out of the effective communication range of the two-way finding system, i.e., when the parent wireless transceiver device receives no return signal from the child wireless transceiver, the parent wireless transceiver device immediately generates an alarm signal, avoiding the child who carries the child wireless transceiver device to run away.

In particular, in order to avoid false alarm of the parent wireless transceiver device, the present preferred embodiment sets the alarm condition to be: the first wireless communication module 119 receives no any return signal after two continuous received time intervals, i.e., the parent wireless transceiver device (first wireless transceiver device 11) identifies the child wireless transceiver device does not exist after received no any return signal from the child wireless transceiver device (second wireless transceiver device 13) in two receiving actions. In other words, if the parent wireless transceiver device receives only one return signal from the child wireless transceiver device after two continuous received time intervals, it does not meet the alarm condition. Thus, the two-way finding system can avoid false alarm when the parent wireless transceiver device is working and the child wireless transceiver device is sleeping. Therefore, the alarm condition of the parent wireless transceiver device is adjustable by changing the number of times in receiving return signals, i.e., the return signal receiving action to meet the alarm condition is not limited to once or twice. Further, the received time interval, the operating time and the sleep time are not limited to the number of seconds set in the present preferred embodiment.

Because the second wireless transceiver device 13 (child wireless transceiver device) needs to continuously generate and transmit return signals for a long period of time, the capacity of the second battery 133 is preferably larger than the capacity of the first, third and fourth batteries 113, 153 and 173.

In the parent-child mode of the present preferred embodiment, the second wireless transceiver device is defined as a child wireless transceiver device, however, in actual practice, any other wireless transceiver device can be selectively defined as a child wireless transceiver device, for example, the first wireless transceiver device, the third wireless transceiver device or the fourth wireless transceiver device can be defined as a child wireless transceiver device. Similarly, the third wireless transceiver device or the fourth wireless transceiver device can be defined as a parent wireless transceiver device, and the related setting and operation are same as the aforesaid first wireless transceiver device.

Further, in the present preferred embodiment, the first, second, third and fourth output modules each have built therein a speaker, a light-emitting device or a vibration motor. If these output modules are equipped with a speaker, the reminder and alarm signals are made by sound. Similarly, if these output modules are equipped with a light-emitting device, the reminder and alarm signals are made by giving off light; if these output modules are equipped with a vibration motor, the reminder and alarm signals are made by vibration. In case light-emitting device is selected, light-emitting diode is preferably used. Further, these output modules can be a combination of a speaker, a light-emitting device and a vibration motor.

Further, in the present preferred embodiment, the two-way finding system consists of four wireless transceiver devices, however, in actual application, using two wireless transceiver devices can establish the two-way finding system, and therefore, the two-way finding system is not limited to the combination of four wireless transceiver devices.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A two-way finding system, comprising:
a first wireless transceiver device comprising a first processor, a first battery, a first input module, a first output module and a first wireless communication module, said first battery, said first input module, said first output module and said first wireless communication module being electrically connected to said first processor, said first processor having stored therein a first identification code and a first communication address; and
a second wireless transceiver device comprising a second processor, a second battery, a second input module, a second output module and a second wireless communication module, said second battery, said second input module, said second output module and said second wireless communication module being electrically connected to said second processor, said second processor having stored therein a second identification code and a second communication address;
wherein said first input module triggers said first processor to generate a second wireless transceiver device calling signal; said first wireless communication module is adapted to transmit said second wireless transceiver device calling signal of said first wireless transceiver device to said second wireless transceiver device; said second wireless transceiver device calling signal of said first wireless transceiver device comprises said first identification code, said first communication address and said second identification code; after said second wireless communication module received said second wireless transceiver device calling signal from said first wireless transceiver device, said second processor generates a reminder signal according to the second identification code contained in said second wireless transceiver device calling signal of said first wireless transceiver device, enabling the reminder signal to be outputted through said second output module; said second input module triggers said second processor to generate a first wireless transceiver device calling signal; said second wireless communication module is adapted to transmit said first wireless transceiver device calling signal of said second wireless transceiver device to said first wireless transceiver device; said first wireless transceiver device calling signal of said second wireless transceiver device comprises said second identification code, said second communication address and said first identification code; after said first wireless communication module received said first wireless transceiver device calling signal from said second wireless transceiver device, said first processor generates a reminder signal according to the first identification code contained in said first wireless transceiver device calling signal of said second wireless transceiver device, enabling the reminder signal to be outputted through said first output module.

2. The two-way finding system as claimed in claim 1, wherein said first input module triggers said first processor to generate a second wireless transceiver device monitoring signal; said first wireless communication module is adapted to transmit said second wireless transceiver device monitoring signal to said second wireless transceiver device; after said second wireless communication module received said second wireless transceiver device monitoring signal from said first wireless transceiver device, said second processor generates a plurality of return signals in a plurality of return cycles according to said second wireless transceiver device monitoring signal of said first wireless transceiver device, enabling said return signals to be transmitted to said first wireless transceiver device by said second wireless communication module; said first processor controls said first wireless communication module to receive each said return signal when a received time interval is up; said first processor generates an alarm signal subject to an alarm condition, said alarm signal being outputted through said first output module, said alarm condition being that said first wireless communication module receives no said return signal when said received time interval is up.

3. The two-way finding system as claimed in claim 2, wherein said alarm condition is that said first wireless communication module receives no said return signal when two continuous said received time intervals are up.

4. The two-way finding system as claimed in claim 2, wherein said first processor controls said first wireless communication module to stop receiving said return signal during each said received time interval; each said return cycle comprises an operating time and a sleep time; said second processor generates said return signals in each said operating time, and stops generating said return signals during each said sleep time, said operating time being a multiple of said sleep time, the time period of said sleep time and the time period of said received time interval are equal.

5. The two-way finding system as claimed in claim 2, wherein a capacity of said first battery is smaller than a capacity of said second battery.

6. The two-way finding system as claimed in claim 2, wherein said first input module and said second input module each comprise a first switch and a second switch, said first processor generating said second wireless transceiver device calling signal when the second switch of said first input module is electrically conducted, said first processor generating said second wireless transceiver device monitoring signal when the first switch and said second switch of said first input module are electrically conducted for a predetermined time interval, said second processor generating said first wireless transceiver device calling signal when the second switch of said second input module is electrically conducted.

7. The two-way finding system as claimed in claim 1, further comprising a third wireless transceiver device, said third wireless transceiver device comprising a third processor, a third battery, a third input module, a third output module and a third wireless communication module, said third battery, said third input module, said third output module and said third wireless communication module being electrically connected to said third processor, said third processor having stored therein a third identification code, a third communication address and an all-call calling code, said first processor and said second processor also having stored therein said all-call calling code, said first input module being operable to trigger said first processor to generate an all-call calling signal, said all-call calling signal being transmitted by said first wireless communication module, the all-call calling signal of said first wireless transceiver device comprising said first identification code, said first communication address and said all-call calling code, said second processor and third processor respectively generate a reminder signal according to said all-call calling code after said second wireless communication module and said third wireless communication module received the all-call calling signal of said first wireless transceiver device, the reminder signals of said second processor and third processor being respectively outputted through said second output module and said third output module, said second input module being operable to trigger said second processor to generate an all-call calling signal, the all-call calling signal of said second input module being transmitted by said second wireless communication module, the all-call calling signal of said second wireless transceiver device containing said second identification code, said second communication address and said all-call calling code, said first processor and said third processor respectively generate a reminder signal according to said all-call calling code after said first wireless communication module and said third wireless communication module received the all-call calling signal of said second wireless transceiver device, the reminder signals of said first processor and said third processor being respectively outputted through said first output module and said third output module, said third input module being operable to trigger said third processor to generate an all-call calling signal, the all-call calling signal of said third input module being transmitted by said third wireless communication module, the all-call calling signal of said third wireless transceiver device containing said third identification code, said third communication address and said all-call calling code, said first processor and said second processor respectively generate a reminder signal according to said all-call calling code after said first wireless communication module and second wireless communication module received the all-call calling signal of said third wireless transceiver device, the reminder signals of said first processor and said second processor being respectively outputted through said output module and said second output module.

8. The two-way finding system as claimed in claim 7, wherein said third input module is operable to trigger said third processor to generate a first wireless transceiver device calling signal and a second wireless transceiver device calling signal, said third wireless communication module being adapted to transmit the first wireless transceiver device calling signal and second wireless transceiver device calling signal of said third wireless transceiver device, the first wireless transceiver device calling signal of said third wireless transceiver device containing said third identification code, said third communication address and said first identification code, the second wireless transceiver device calling signal of said third wireless transceiver device containing said third identification code, said third communication address and said second identification code, said first processor generating a reminder signal according to the first identification code of the first wireless transceiver device calling signal of said third wireless transceiver device after said first wireless communication module received the first wireless transceiver device calling signal of said third wireless transceiver device, the reminder signal of said first processor being outputted through said first output module, said second processor generating a reminder signal according to the second identification code contained in the second wireless transceiver device calling signal of said third wireless transceiver device after said second wireless communication module received the second wireless transceiver device calling signal of said third wireless transceiver device, the reminder signal of said second processor being outputted through said second output module, said first input module being operable to trigger said first processor to generate a third wireless transceiver device calling signal, the third wireless transceiver device calling signal of said first wireless transceiver device being transmitted by said first wireless communication module, the third wireless transceiver device calling signal of said first wireless transceiver device containing said first identification code, said first communication address and said third identification code, said third processor generating a reminder signal according to the third identification code contained in the third wireless transceiver device calling signal of said first wireless transceiver device after said third wireless communication module received the third wireless transceiver device calling signal of said first wireless transceiver device, the reminder signal of said third processor being outputted through said third output module, said second input module being operable to trigger said second processor to generate a third wireless transceiver device calling signal, the third wireless transceiver device calling signal of said second wireless transceiver device being transmitted by said second wireless communication module, the third wireless transceiver device calling signal of said second wireless transceiver device containing said second identification code, said second communication address and said third identification code, said third processor generating a reminder signal according to the third identification code contained in the third wireless transceiver device calling signal of said second wireless transceiver device after said third wireless communication module received said third wireless transceiver device calling signal of second wireless transceiver device, the reminder signal of said third processor being outputted through said third output module.

9. The two-way finding system as claimed in claim 8, wherein said first input module, said second input module and said third input module each comprise a first switch, a second switch, a third switch and an all-call switch, said first processor generating said second wireless transceiver device calling signal when the second switch of said first input module is electrically conducted, said first processor generating said third wireless transceiver device calling signal when the third switch of said first input module is electrically conducted, said first processor generating said all-call calling signal when the all-call switch of said first input module is electrically conducted, said second processor generating said first wireless transceiver device calling signal when the first switch of said second input module is electrically conducted, said second processor generating said third wireless transceiver device calling signal when the third switch of said second input module is electrically conducted, said second processor generating said all-call calling signal when the all-call switch of said second input module is electrically conducted, said third processor generating said first wireless transceiver device calling signal when the first switch of said third input module is electrically conducted, said third processor generating said second wireless transceiver device calling signal when the second switch of said third input module is electrically conducted, said third processor generating said all-call calling signal when the all-call switch of said third input module is electrically conducted.

10. The two-way finding system as claimed in claim 7, wherein said first output module, said second output module and said third output module each have built therein at least one of a speaker, a light-emitting device and a vibration motor.

11. The two-way finding system as claimed in claim 2, wherein said first output module and said second output module each have built therein at least one of a speaker, a light-emitting device and a vibration motor.

12. The two-way finding system as claimed in claim 1, wherein said first output module and said second output module each have built therein at least one of a speaker, a light-emitting device and a vibration motor.
